(19) United States
(12) Patent Application Publication
(10) Pub. No.: US 2010/0198750 A1
(43) Pub. Date: Aug. 5, 2010

(54) Systems and methods for financial planning

(76) Inventors: David Ron, Ganey Tikva (IL); Eldad Taub, Reut (IL); Robet Schumann, Buena Vista, CO (US)

Correspondence Address: The Law Office of Michael E. Kondoudis, 888 16th Street, N.W., Suite 800, Washington, DC, 20006, US

(21) Appl. No.: 12/691,191

(22) Filed: Jan. 21, 2010

Related U.S. Application Data
(60) Provisional application No. 61/146,171, filed on Jan. 21, 2009.

(51) Int. Cl. G06Q 40/00

(52) U.S. Cl. 705/36 T; 705/35; 705/36 R

(57) ABSTRACT

Various computerized servers such as, for example, a computerized server including: a) an interview engine configured to prompt data input pertaining to a user and the user's assets from a user connected to the server; b) an analytic module adapted to apply a set of predetermined rules to said data input, formulate an asset re-allocation suggestion and to output an estimate of potential savings from implementing said asset re-allocation suggestion; and c) a display engine configured to present the estimate to the user are disclosed.

### CROSS REFERENCE TO RELATED APPLICATIONS

This application claims the benefit of 35 U.S.C. §119(e) from provisional application 61/146,171 filed Jan. 21, 2009 which is fully incorporated herein by reference including its appendices.

### FIELD OF THE INVENTION

This invention relates systems and methods for providing financial planning information.

### BACKGROUND OF THE INVENTION

WO/2007/099539 by TKT Technologies Ltd. (TKT) describes technology and administrative services for client interviewing and data collection including a graphical user interface for conducting an interactive interview.

Bert Whitehead's book “Why Smart People Do Stupid Things with Money: Overcoming Financial Dysfunction” (3^{rd} ed.; (2007) Sterling Publishing Co., Inc New York) describes a financial planning methodology adopted by the Alliance of Cambridge Advisors Inc., (ACA). ACA is widely practiced by Certified Financial Planners (CFPs), members of ACA across the United States. ACA applies Modern Portfolio Theory and Behavioral Economics to the financial decision making process of individuals, as opposed to financial institutions.

There are numerous financial position calculators (FPC) available on the Internet. The following list does not purport to be exhaustive.

FinAid Page LLC (Mark Kantrowitz, Publisher) provide a variety of “Financial Aid Calculators” designed to help users plan for future college tuition expenses. The calculators are designed to implement simple arithmetic formulas based upon a few inputs from the user.

Bloomberg LLP offers an online retirement calculator which accepts inputs pertaining to the user, their current and projected income, their projected retirement need and pension benefits and provides a short textual and graphic report as an output.

Additional online retirement calculators are available from American association of retired persons (AARP) and MSN.

The government of New Zealand offers a variety of financial calculators at sortedDOTorgDOTnz/life-stages.

Additional online financial advice is available at:

### SUMMARY OF THE INVENTION

An aspect of some embodiments of the invention relates to providing financial planning advice to an individual across a computerized network. In some exemplary embodiments of the invention, the advice is prepared by a remote server configured for that purpose. Optionally, the advice is customized to the individual.

An aspect of some embodiments of the invention relates to soliciting financial planning information from an individual across a computerized network. In some exemplary embodiments of the invention, the soliciting occurs during an online interview. Optionally, the interview questions vary from individual to individual. For example a response to a key question may cause one or more subsequent questions to be included in, or eliminated from, the interview.

An aspect of some embodiments of the invention relates to providing a financial planning report to a certified financial planner prior to an initial meeting with a client. As used here, the word “meeting” includes face-to-face interviews, telephone or voice over Internet (VoIP) interviews and online chat interviews.

An aspect of some embodiments of the invention relates to graphic presentation of a computed financial behavior metric to a user. Optionally, the graphic presentation includes one or more of colors, a degree of fill and a percentage. In some exemplary embodiments of the invention, there is provided a computerized server including: a) an interview engine configured to prompt data input pertaining to a user and the user's assets from a user connected to the server; b) an analytic module adapted to apply a set of predetermined rules to the data input, formulate an asset re-allocation suggestion and to output an estimate of potential savings from implementing the asset re-allocation suggestion; and c) a display engine configured to present the estimate to the user.

Optionally, the display engine is configured to present the asset re-allocation suggestion to the user.

Optionally, the predetermined rules comprise tax regulations.

Optionally, asset re-allocation suggestion is presented to the user for a fee.

In some exemplary embodiments of the invention, there is provided a computerized server including: a) an interview engine configured to prompt data input pertaining to financial life stage and risk capacity from a user connected to the server; b) an analytic module adapted to apply a set of predetermined rules to the data input and to output an estimate of financial position; and c) a display engine configured to present the estimate of financial position to the user.

In some exemplary embodiments of the invention, there is provided a computerized server including: a) an interview engine configured to prompt data input pertaining to financial life stage and asset allocation including real estate holdings from a user connected to the server; b) an analytic module adapted to apply a set of predetermined rules to the data input and output asset allocation advice including an evaluation of what percentage of assets should be allocated to real estate; and c) a display engine configured to present the asset allocation advice to the user.

In some exemplary embodiments of the invention, there is provided a computerized server including: a) an interview engine configured to prompt current asset data input and data input pertaining to financial life stage from a user connected to the server; b) an analytic module adapted to compare the data input to a predetermined financial planning timeline; and c) a display engine configured to present a current position on the financial planning timeline to the user.

In some exemplary embodiments of the invention, there is provided a computerized server including: a) an interview engine configured to prompt data input pertaining to a user and at least one of: (i) the user's use of available tax shelters; and (ii) financial management fees paid by the user from a user connected to the server; b) an analytic module adapted to apply a set of predetermined rules to the data input, and to output an estimate of potential savings from implementing an asset re-allocation suggestion; and c) a display engine configured to present the estimate to the user.

In some exemplary embodiments of the invention, there is provided a method of providing financial planning advice including: a) presenting data output from a display engine according to any of the preceding claims to a certified financial planner (CFP); b) conducting an initial interview between the user and the CFP subsequent to the presenting.

In some exemplary embodiments of the invention, there is provided a method of automating financial planning including: a) prompting data inputs pertaining to financial life stage and risk capacity in a machine readable format; b) processing the data inputs using a machine implemented algorithm to generate financial planning advice; and c) providing an output including the financial planning advice.

In some exemplary embodiments of the invention, there is provided a method of providing financial planning information across a network including: a) prompting data input pertaining to financial life stage and asset allocation including real estate holdings from a user by means of an automated server; b) employing an analytic module to apply a set of predetermined rules to the data input and to output asset allocation advice; and c) providing the asset allocation advice to the user by means of the automated server.

In some exemplary embodiments of the invention, there is provided a method of providing tax advice across a network including: a) prompting data input pertaining to financial life stage from a user by means of an automated server; b) employing an analytic module to apply a set of predetermined rules to data input and a predetermined financial planning timeline; and c) indicating to the user their position on the predetermined financial planning timeline by means of the automated server.

In some exemplary embodiments of the invention, there is provided a method of rendering financial planning data comprehensible, the method including: a) prompting data input pertaining to financial life stage and risk capacity from a user by means of an automated server; b) employing an analytic module to compare the data input to a predetermined financial planning timeline; and c) displaying to the user their current position on the financial planning timeline.

In some exemplary embodiments of the invention, there is provided a computerized server including: a) an interview engine configured to prompt data input pertaining to financial behavior from a user connected to the server; b) an analytic module adapted to compare the data input to a projected future need and determine a behavior metric; and c) a display engine configured to transform the behavior metric to graphic format and present the metric to the user in the graphic format.

Optionally, the data input includes at least one input selected from the group consisting of savings rate (SL), available liquid assets, pension funding ratio, home equity and high interest rate loans.

Optionally, the available liquid assets consider base liquidity separately from emergency reserves.

Optionally, the behavior metric is selected from the group consisting of a savings rate indicator, a base liquidity indicator,

an emergency liquidity indicator, a pension funding ratio, a home size ratio, a real estate leverage indicator and a high interest rate loan ratio.

In some exemplary embodiments of the invention, there are provided machine instructions for financial planning and/or for configuring a computer and/or server to provide financial planning output.

In some exemplary embodiments of the invention, there are provided Machine readable instructions for financial planning, the instructions including: a) an interview engine operable to prompt data input pertaining to financial life stage and risk capacity via a user interface; b) an analytic module adapted to apply a set of predetermined rules to the data input and to output an estimate of financial position; and c) a display engine configured to output the estimate of financial position to a second user interface.

In some exemplary embodiments of the invention, there are provided Machine readable instructions for financial planning, the instructions including: a) an interview engine operable to prompt data input pertaining to financial life stage and asset allocation including real estate holdings via a user interface; b) an analytic module adapted to apply a set of predetermined rules to the data input and to output asset allocation advice including an evaluation of what percentage of assets should be allocated to real estate; and c) a display engine configured to output the asset allocation advice to a second user interface.

In some exemplary embodiments of the invention, there are provided Machine readable instructions for financial planning, the instructions including: a) an interview engine operable to prompt current asset data input and data input pertaining to financial life stage via a user interface; b) an analytic module adapted to compare the data input to a predetermined financial planning timeline; and c) a display engine configured to output a current position on the financial planning timeline to a second user interface.

Optionally, the user interface and the second user interface are a same user interface.

Optionally, the user interface is accessible to a user seeking financial planning advice and the second user interface is accessible to a certified financial planner (CFP).

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

For purposes of this specification and the accompanying claims, the terms “allocation” and “re-allocation” and their derivatives should be viewed as synonymous.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic representation of a system including a computerized system according to some exemplary embodiments of the invention;

FIG. 2A is a schematic representation of an exemplary analytic module suitable for use in a server residing in a computerized system according to some exemplary embodiments of the invention;

FIG. 2B is a schematic representation of another exemplary analytic module suitable for use in a server residing in a computerized system according to some exemplary embodiments of the invention;

FIG. 2C is a schematic representation of yet another exemplary analytic module suitable for use in a server residing in a computerized system according to some exemplary embodiments of the invention;

FIG. 2D is a schematic representation of still another exemplary analytic module suitable for use in a server residing in a computerized system according to some exemplary embodiments of the invention;

FIG. 2E is a schematic representation of another exemplary analytic module suitable for use in a server residing in a computerized system according to some exemplary embodiments of the invention;

FIG. 2F is a schematic representation of still another exemplary analytic module suitable for use in a server residing in a computerized system according to some exemplary embodiments of the invention;

FIG. 3 is simplified flow diagram of a method according to one exemplary embodiment of the invention;

FIG. 4 is simplified flow diagram of a method according to one exemplary embodiment of the invention;

FIG. 5 is simplified flow diagram of another method according to one exemplary embodiment of the invention;

FIG. 6 is simplified flow diagram of an additional method according to one exemplary embodiment of the invention;

FIG. 7 is simplified flow diagram of another additional method according to one exemplary embodiment of the invention;

FIG. 8A is a plot of an exemplary financial well being metric, net worth/income as a function of age;

FIG. 8B is a plot of another exemplary financial well being metric, liquid assets/annual expenses as a function of age.

FIG. 9 is an exemplary graph depicting progress of two individuals (a and b) with the vertical axis divided into stages (A-F);

FIG. 10 is a graph illustrating expected migration from one financial stage to the other with increasing age according to some exemplary embodiments of the invention;

### DETAILED DESCRIPTION OF EMBODIMENTS

Embodiments of the invention relate to computerized systems and methods for providing financial planning advice to one or more users.

Specifically, some embodiments of the invention can be used to provide financial planning advice to a user across a network, such as the Internet and/or reduce financial planning costs.

The principles and operation of a computerized systems and/or computerized servers and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Overview

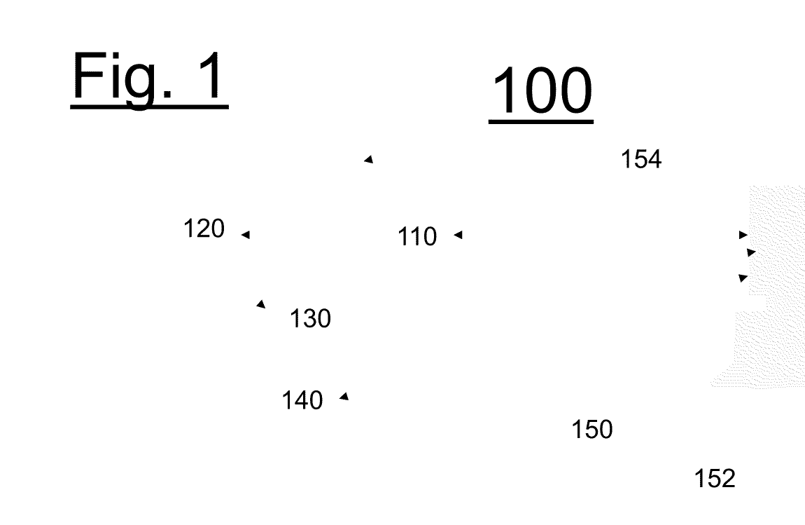

FIG. 1 is a schematic representation of architecture of a computerized server 100. Server 100 is connectable to a plurality of user clients 150, via a network (e.g. the Internet). A single user client 150 is depicted for clarity, although in actual practice a much larger number of clients 150 would communicate with server 100 concurrently and/or sequentially. Similarly, although user client 150 is depicted as a computer, other types of devices can function as user clients in the context of many exemplary embodiments of the invention. These other types of devices include, but are not limited to, personal digital assistants (PDAs) and cellular telephones.

Depicted exemplary server 100 includes an interview engine 110 designed and configured to prompt a user to input data via user client 150. In some exemplary embodiments of the invention, prompting is by displaying text questions on a display 154 of user client 150. In various exemplary embodiments of the invention, data input is via keyboard 152 or any other available user input device. According to various exemplary embodiments of the invention, the type of data inputs prompted by engine 120 can vary.

Exemplary interview engines 100 are described in WO 2007/099539 which is fully incorporated herein by reference.

Depicted exemplary server 100 also includes an analytic module 120 adapted to apply a set of predetermined rules to data inputs provided by interview engine 110. Module 120 transforms the data inputs into an output signal which is relayed to depicted exemplary display engine 130. According to various exemplary embodiments of the invention, the type of predetermined rules applied by module 120 can vary. According to various exemplary embodiments of the invention analytic module 120 and/or interview engine may perform one or more of the functions or tasks described hereinbelow. For the sake of clarity, specific exemplary embodiments are described in terms of relevant numbered machine parts differentiated by letters. It is to be understood that in actual practice, a single hardware component indicated by a reference numeral may perform functions indicated by several different letters.

Depicted exemplary server 100 also includes display engine 130 designed and configured to transform the output signal from module 120 into a presentation format for presentation to the user via user client 150 (e.g. on display 154). Optionally, transformation into display format can include one or more of application of color, association with icons, placement on a continuum and expression of a difference relative to a theoretically desired value.

In some exemplary embodiments of the invention, server 100 includes a fee collection module adapted to collect a fee via user client 150 in return for data transformations performed on data inputs by server 120. Fee collection can be using any means known in the art.

Exemplary Savings Preview Server

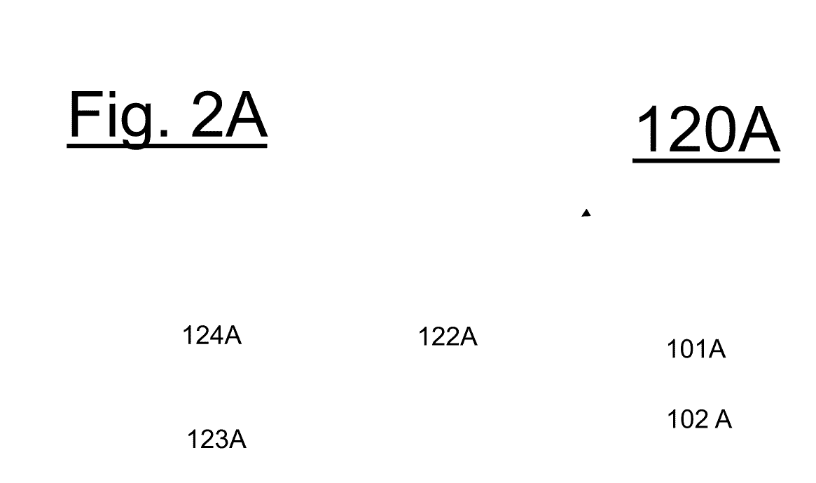

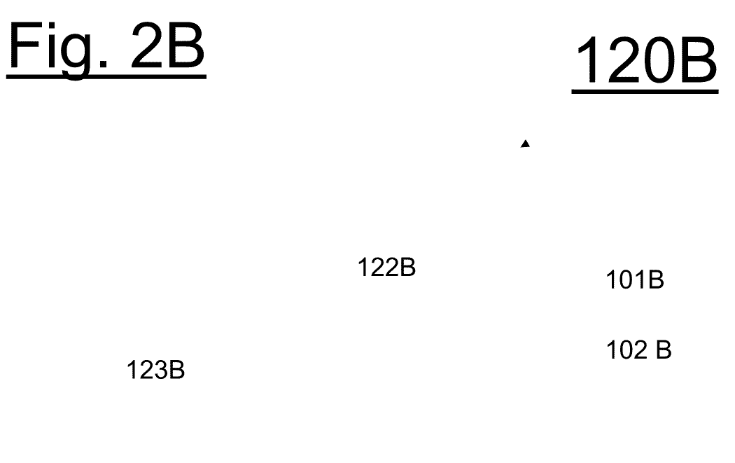

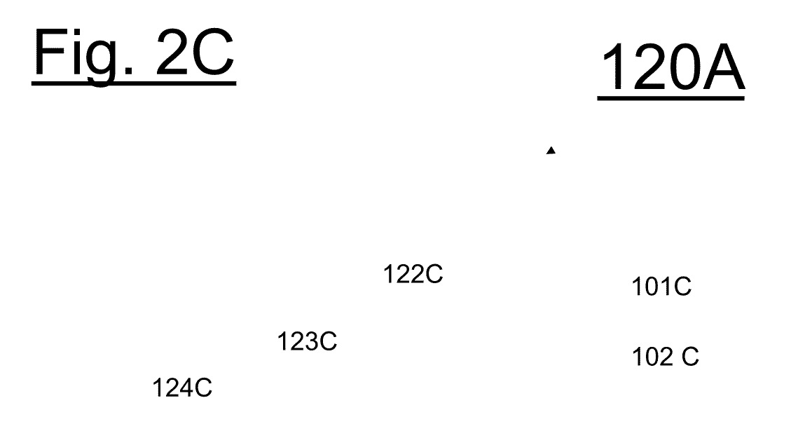

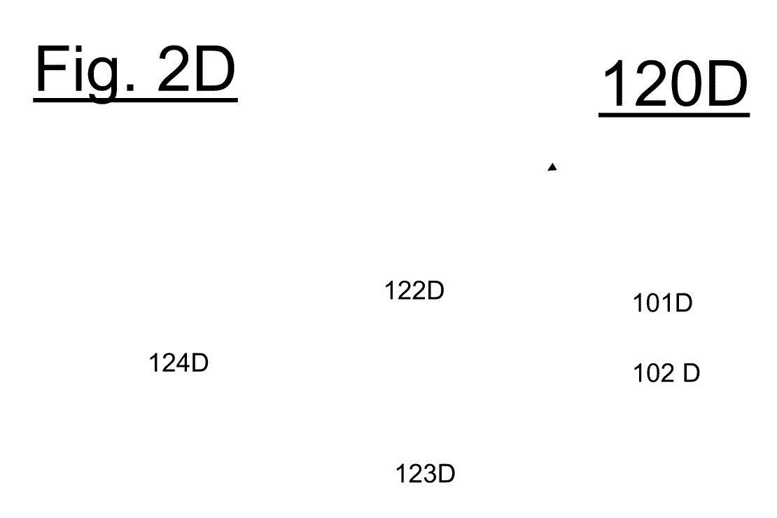

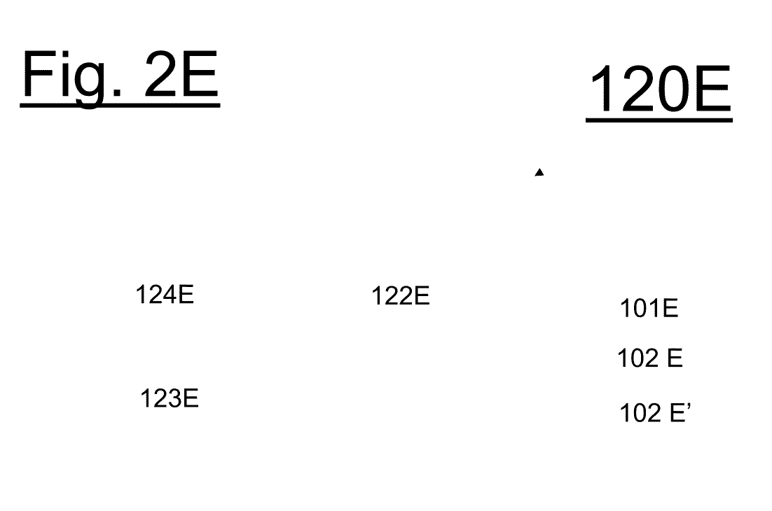

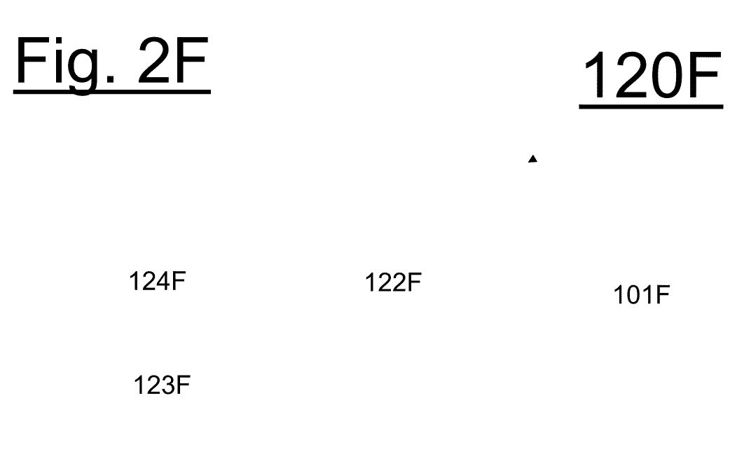

FIG. 2A depicts an exemplary analytic module 120A in greater detail. Module 120A should be understood to function as a module 120 in server 100 as described in the context of FIG. 1. In some exemplary embodiments of the invention, server 100 includes an interview engine 110A configured to prompt data input pertaining to a user (101A) and the user's assets (102A) from a user connected to the server via user client 150.

Data input 101A pertaining to a user includes, but is not limited to, current age, projected retirement age, number of dependents and lifestyle information. Lifestyle information includes current and projected spending habits.

Data input 102A pertaining to the user's assets includes, but is not limited to, current savings, current investments, projected future savings and/or investments and real estate equity.

In some exemplary embodiments of the invention, analytic module 120A is adapted to apply a set of predetermined rules 122A to data inputs 101A and 102A, formulate an asset re-allocation suggestion 123A and to output an estimate 124A of potential savings from implementing suggestion 123A. Optionally, rules 122A comprise tax regulations. According to some exemplary embodiments of the invention rules 122A direct analytic module 120A to a look up table. Optionally, the lookup table is on an external server or other computerized resource. One of ordinary skill in the art will be able to locate, and implement links to, relevant look-up tables.

In some exemplary embodiments of the invention, display engine 130 is configured to present estimate 124A to the user. Optionally, display engine 130 is configured to present suggestion 123A to the user. In some exemplary embodiments of the invention, suggestion 123A is presented to the user for a fee.

Exemplary Financial Position Server

FIG. 2B depicts an exemplary analytic module 120B in greater detail. Module 120B should be understood to function as a module 120 in server 100 as described in the context of FIG. 1. In some exemplary embodiments of the invention, server 100 includes an interview engine 110B configured to prompt data input pertaining to a user's financial life stage (101B) and the user's risk capacity (102B) from a user connected to the server via user client 150.

In some exemplary embodiments of the invention, analytic module 120B is adapted to apply a set of predetermined rules 122B to data inputs 101B and 102B, formulate an estimate of financial position 123B and to output estimate 123B. Optionally, rules 122B are as set forth hereinbelow. Equations 1 to 9 and/or table 1 present exemplary financial position calculations and presentation formats.

According to various exemplary embodiments of the invention, display engine 130 is configured to present estimate 123B to the user in various ways. Optionally, estimate 123B can be presented textually and/or numerically and/or graphically. Alternatively or additionally, estimate 123B can be presented in relative and/or absolute terms.

Exemplary Allocation Server

FIG. 2C depicts an exemplary analytic module 120C in greater detail. Module 120C should be understood to function as a module 120 in server 100 as described in the context of FIG. 1. In some exemplary embodiments of the invention, server 100 includes an interview engine 110C configured to prompt data input pertaining to the user's financial life stage (101C) and asset allocation including real estate holdings (102C) from the user connected to the server via user client 150.

In some exemplary embodiments of the invention, analytic module 120C is adapted to apply a set of predetermined rules 122C to data inputs 101C and 102C and output asset allocation advice 124C including an evaluation 123C of what percentage of assets should be allocated to real estate. Optionally, rules 122C are as set forth hereinbelow in sections entitled “Exemplary financial life stage determination” and “Exemplary Diversification rules among Interest earning, Equities, and Real estate assets”.

According to exemplary embodiments of the invention, display engine 130 is configured to present asset allocation advice 124C and/or evaluation 123C of what percentage of assets should be allocated to real estate to the user. Presentation formats can vary as described hereinabove in the context of FIG. 2B.

Exemplary Financial Position Server

FIG. 2D depicts an exemplary analytic module 120D in greater detail. Module 120D should be understood to function as a module 120 in server 100 as described in the context of FIG. 1. In some exemplary embodiments of the invention, server 100 includes an interview engine 110D configured to prompt current asset data input 101D and data input 102D pertaining to financial life stage from a user connected to the server via user client 150.

In some exemplary embodiments of the invention, analytic module 120D is adapted to adapted use predetermined rules 122D to compare data inputs 101D and 102D to a predetermined financial planning timeline 123D and to output a current position 124D relative to timeline 123D. Optionally, rules 122D are as set forth hereinbelow, for example in tables 2 and 3 and with reference to FIG. 10.

In some exemplary embodiments of the invention, display engine 130 is configured to predetermined financial planning timeline 123D with current position 124D indicated thereupon. Optionally, this presentation format aids the user in comprehending data output.

Additional Exemplary Potential Savings Preview Server

FIG. 2E depicts an exemplary analytic module 120E in greater detail. Module 120E should be understood to function as a module 120 in server 100 as described in the context of FIG. 1. In some exemplary embodiments of the invention, server 100 includes an interview engine 110E configured to prompt data input 101E pertaining to a user as well as data input 102E pertaining to the user's use of available tax shelters and/or data input 102E′ pertaining to financial management fees paid by the user. Sections entitled “Exemplary impact of Tax regulation on asset re-allocation recommendations” and “Optimizing investment expenses” hereinbelow describe exemplary calculations performed by module 120E according to some embodiments of the invention.

In some exemplary embodiments of the invention, analytic module 120E is adapted to apply a set of predetermined rules 122E to data inputs 101E and 102E and/or 102E′, formulate an asset re-allocation suggestion 123E and to output suggestion 123E and/or an estimate 124E of potential savings from implementing suggestion 123E. Optionally, rules 122E comprise tax regulations and/or analyses of management fees. According to some exemplary embodiments of the invention rules 122E direct analytic module 120E to a look up table as described hereinabove.

According to various exemplary embodiments of the invention, display engine 130 is configured to present estimate 124E to the user and/or suggestion 123E to the user. In some exemplary embodiments of the invention, suggestion 123E is presented to the user for a fee.

Exemplary Financial Habits Server

FIG. 2F depicts an exemplary analytic module 120F in greater detail. Module 120F should be understood to function as a module 120 in server 100 as described in the context of FIG. 1. In some exemplary embodiments of the invention, server 100 includes an interview engine 110F configured to prompt data input 101F pertaining to financial behavior from a user connected to the server via user client 150.

In some exemplary embodiments of the invention, analytic module 120F is adapted to apply a set of predetermined rules 122F to data inputs 101F in order to compare data input 101F to a projected future need and determine one or more behavior metrics 123F and/or 124F. Optionally, rules 122F are as described hereinbelow. According to some exemplary embodiments of the invention rules 122F are an application of ratios (such as savings ratio) in comparison to pre defined targets. For example, a desired window of 10-20% savings might be defined. In that case, below 10% or above 20% is evaluated as “bad savings habits”.

In some exemplary embodiments of the invention, display engine 130 is configured to transform the metrics 123F and/or 124F to graphic format and present the metric(s) to the user in the graphic format

According to some exemplary embodiments of the invention data input 101F includes current savings rate (SL) and/or available liquid assets and/or pension funding ratio and/or home equity and/or high interest rate loans.

For purposes of this specification and the accompanying claims, the phrase “high interest rate loans” refers to loans with an interest rate that is more than 3% above the average mortgage interest rate in the relevant jurisdiction at the relevant time. Credit card debt typically falls in this category.

According to some exemplary embodiments of the invention analysis of available liquid assets considers base liquidity separately from emergency reserves.

For purposes of this specification and the accompanying claims, the phrase “base liquidity” refers to assets including cash or cash equivalents such as checking accounts, savings, money markets or CDs maturing in less than 18 months.

For purposes of this specification and the accompanying claims, the phrase “emergency reserves” refers to assets such as US Savings Bonds and/or liquid assets held inside some type of tax-advantaged account, such as a CD inside an IRA or the cash value of a fixed rate life insurance policy.

Alternatively or additionally, according to various exemplary embodiments of the invention behavior metrics 123F and/or 124F include one or more of a savings rate indicator, a base liquidity indicator, an emergency liquidity indicator, a pension funding ratio, a home size ratio, a real estate leverage indicator and a high interest rate loan ratio.

For purposes of this specification and the accompanying claims, the phrase “Pension funding ratio” indicates a measure of utilization of qualified tax shelters.

For purposes of this specification and the accompanying claims, the phrase “home size ratio” indicates a comparison of Fair Market Value of a home with the owner's income.

For purposes of this specification and the accompanying claims, the phrase, “real estate leverage” indicates the quotient of fair market value divided by owner equity.

Exemplary Machine Readable Media

According to some exemplary embodiments of the invention programming information for a server and/or a user client is provided in a distributable form. Programming information can be provided in any machine readable format known in the art, including, but not limited to, one or more packets transported across a network and/or CD ROM disc and/or a DVD disc.

According to some exemplary embodiments of the invention the machine readable instructions for financial planning include an interview engine operable to prompt data input pertaining to financial life stage and risk capacity via a user interface. Exemplary calculations of financial life stage and risk capacity are presented below. Alternatively or additionally, the machine readable instructions can include an analytic module adapted to apply a set of predetermined rules to the data input and to output an estimate of financial position. Exemplary means of calculating financial position are presented hereinbelow. Alternatively or additionally, the machine readable instructions can include a display engine configured to output the estimate of financial position to a second user interface.

Alternatively or additionally, in some exemplary embodiments of the invention the machine readable instructions for financial planning include an interview engine operable to prompt data input pertaining to financial life stage and asset allocation including real estate holdings via a user interface. Descriptions of suitable exemplary data inputs for financial life stage and asset allocation including real estate holdings are presented hereinbelow. Alternatively or additionally, the instructions can included an analytic module adapted to apply a set of predetermined rules to the data input and to output asset allocation advice including an evaluation of what percentage of assets should be allocated to real estate. Alternatively or additionally, the instructions include a display engine configured to output the asset allocation advice to a second user interface.

Alternatively or additionally, in some exemplary embodiments of the invention the machine readable instructions for financial planning include an interview engine operable to prompt current asset data input and data input pertaining to financial life stage via a user interface and/or an analytic module adapted to compare the data input to a predetermined financial planning timeline, Examples of data input pertaining to financial life stage and a predetermined financial planning timeline are provided hereinbelow. Alternatively or additionally, the instructions include a display engine configured to output a current position on the financial planning timeline to a second user interface.

According to various exemplary embodiments of the invention the user interface and the second user interface can be a same user interface or separate user interface. According to some exemplary embodiments of the invention the user interface and second user interfaces are a same user interface on a local computer operated by a user. According to some exemplary embodiments of the invention, the first user interface is accessible to a user seeking financial planning advice and the second user interface is accessible to a certified financial planner (CFP). Optionally, the user and the CFP confer based upon one or more reports and/or metrics provided to the CFP on the second user interface.

Exemplary Use Scenario

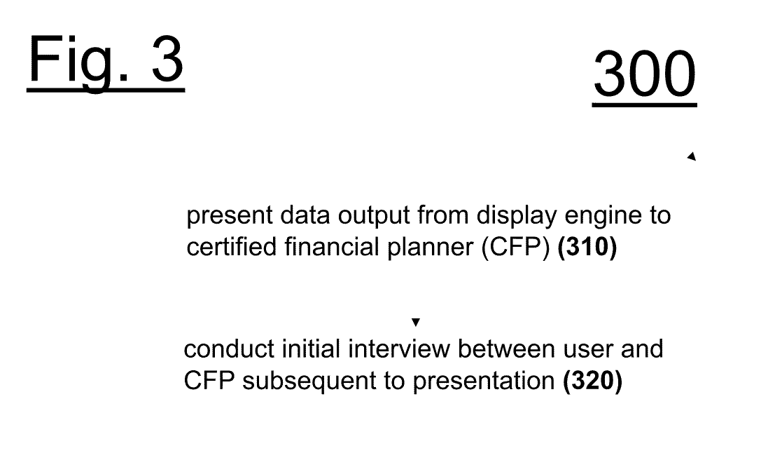

FIG. 3 is a simplified flow diagram of a method 300 of providing financial planning advice which utilizes one or more of the server types and/or machine readable media types described hereinabove. Method 300 includes presenting 310 data output from a display engine 130 as described hereinabove to a certified financial planner (CFP) and conducting 320 an initial interview between the user and the CFP subsequent to presenting 310. Optionally, method 300 contributes to a reduction in financial planning costs from for the user and/or a reduction in overhead costs for the CFP and/or an ability of the CFP to serve a greater number of clients (i.e. users) and/or an ability of the CFP to serve remote users.

Exemplary Methods of Automating Financial Planning

Methods described in this section are performed with the aid of servers and/or computer readable media of one or more types described hereinabove.

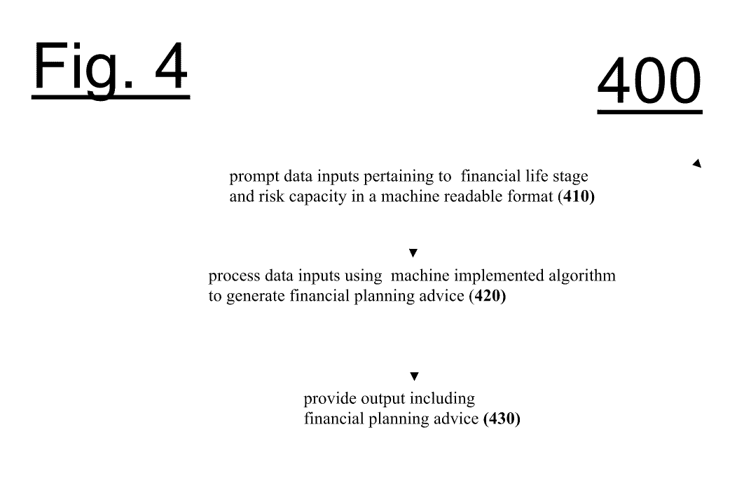

FIG. 4 is a simplified flow diagram which illustrates an exemplary method, depicted generally as 400, of automating financial planning Depicted exemplary method 400 includes prompting 410 data inputs pertaining to financial life stage and risk capacity in a machine readable format, processing 420 the data inputs using a machine implemented algorithm to generate financial planning advice and providing 430 an output including the financial planning advice. See sections entitled “Exemplary financial life stage determination” and/or “Exemplary Risk capacity determination” hereinbelow for additional details.

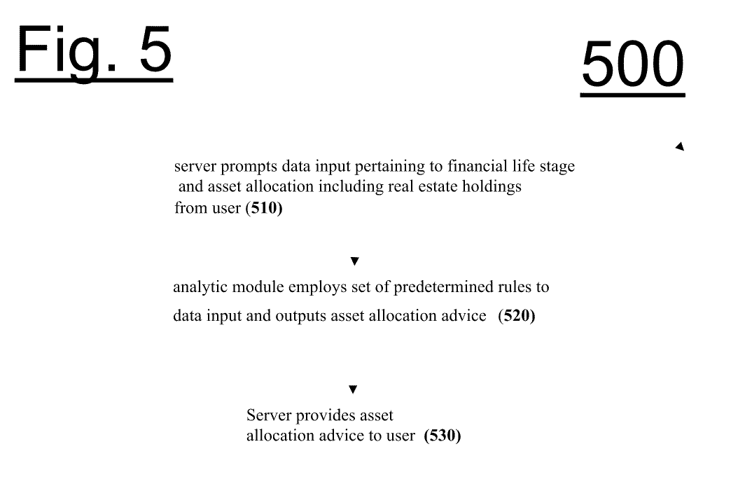

FIG. 5 is a simplified flow diagram which illustrates an exemplary method, depicted generally as 500, of providing financial planning information across a network. Depicted exemplary method 500 includes prompting 510 data input pertaining to financial life stage and asset allocation including real estate holdings from a user by means of an automated server. Method 500 also includes employing 520 an analytic module to apply a set of predetermined rules to the data input and to output asset allocation advice and providing 530 the asset allocation advice to the user by means of the automated server.

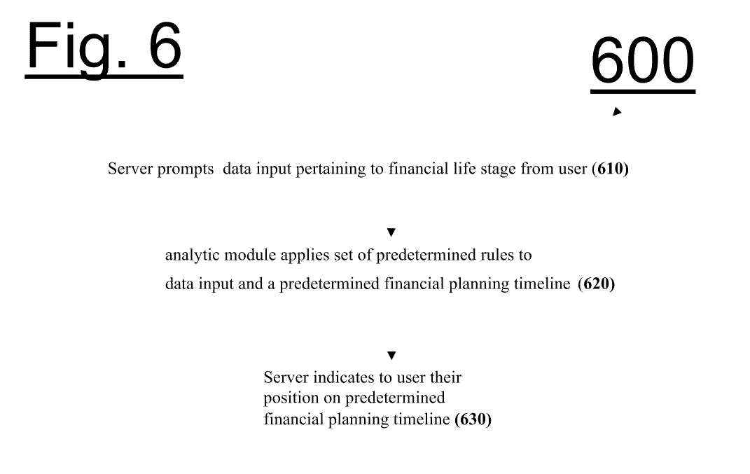

FIG. 6 is a simplified flow diagram which illustrates an exemplary method, depicted generally as 600, of providing tax advice across a network. Depicted exemplary method 600 includes prompting 610 data input pertaining to financial life stage from a user by means of an automated server and employing 620 an analytic module to apply a set of predetermined rules to data input and a predetermined financial planning timeline. Output of method 600 is an indication 630 to the user of their position on the predetermined financial planning timeline provided by the automated server.

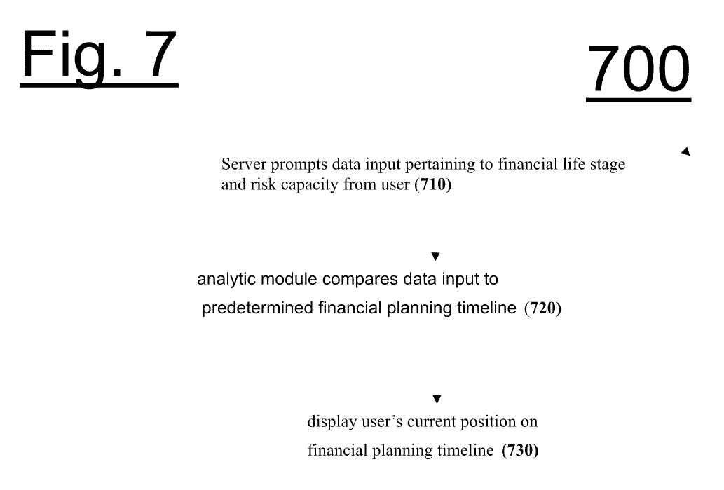

FIG. 7 is a simplified flow diagram which illustrates an exemplary method, depicted generally as 600, of rendering financial planning data comprehensible. Depicted exemplary method 600 includes prompting 710 data input pertaining to financial life stage and risk capacity from a user by means of an automated server, employing an analytic module to compare 720 the data input to a predetermined financial planning timeline and displaying to the user their current position on the financial planning timeline.

Exemplary Calculation Algorithms

The following rules and equations demonstrate, by example, how the theoretical goals of various exemplary embodiments of the invention can be achieved in a computerized system. Financial planners familiar with the underlying financial theories were surprised by the accuracy and/or utility of machine implemented analyses of specific users. The specific algorithms presented can be used in various combinations to achieve various types of analyses according to different embodiments of the invention. Similarly, the exemplary algorithms presented hereinbelow can be supplemented and/or replace by other algorithms. According to various exemplary embodiments of the invention concepts such as Financial Life stage determination and/or Financial planning timeline deviation and/or Risk capacity determination and/or Assets reallocation recommendations and/or Diversification rules among Interest earning, Equities, and Real estate assets and/or Tax regulation impact on assets allocation recommendations and/or Optimizing tax shelter utilization and/or Optimizing investment expenses are converted to machine implemented calculations using one or more appropriate rules.

Exemplary Financial Life Stage Determination

Typically, the financial services industry classifies users by the size of their portfolio. Such classification serves the industry itself more than the individual user. The reason is that most business models in the financial services industry are based on commissions related in one or more ways to user portfolio size. According to some exemplary embodiments of the invention, the financial well being of users is measured and analyzed in a more comprehensive manner. Optionally, exemplary embodiments of the invention recognize that users are people that go through various stages in building their financial assets and may take actions that reduce portfolio size (e.g. taking a mortgage and/or making a down payment on a home). Although these, or analogous, actions can reduce the size of a user's investment portfolio they can also serve to build wealth in real assets. The financial services industry downgrades such users since their portfolio size decreases even though, from the users' point of view, financial position may actually improve as a result of these (or analogous) actions.

An important factor in measuring financial well being is time. Younger people often possess less financial assets than older people, although they may have more opportunity to build financial assets to serve future needs. This principle is illustrated by comparing a young person with the right income level and saving habits, to an older person approaching retirement age that lacks sufficient financial assets for retirement. Although the older person may have more financial assets than the younger one, the financial well being of the younger person may be better.

According to some exemplary embodiments of the invention different life circumstances and stages of individual users are considered when evaluating financial well being. Optionally, measurement of a user's financial well being is made time dependent by evaluating their net worth. In some exemplary embodiments of the invention, net worth includes financial and non-financial assets such as real estate and other non-marketable assets as well as future goals and their degree of imminence.

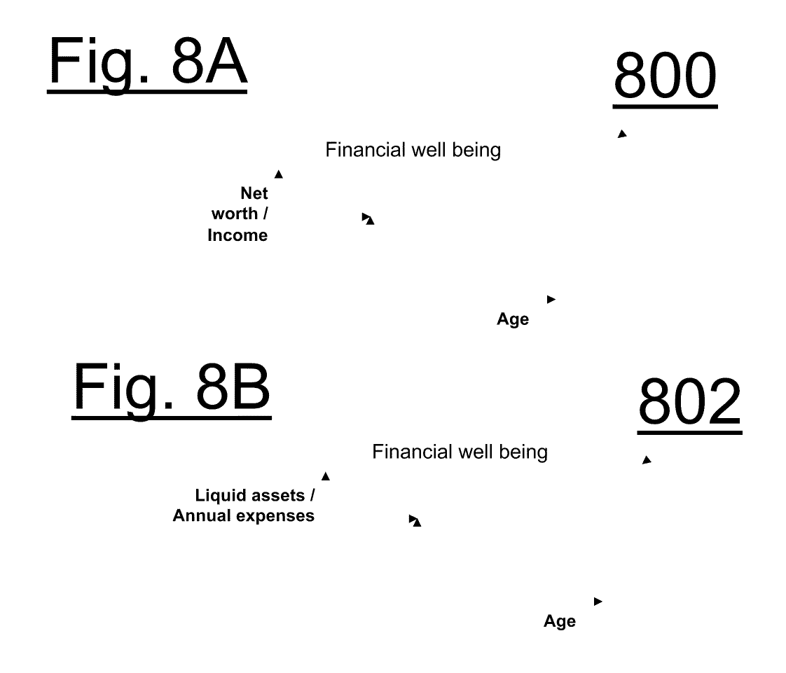

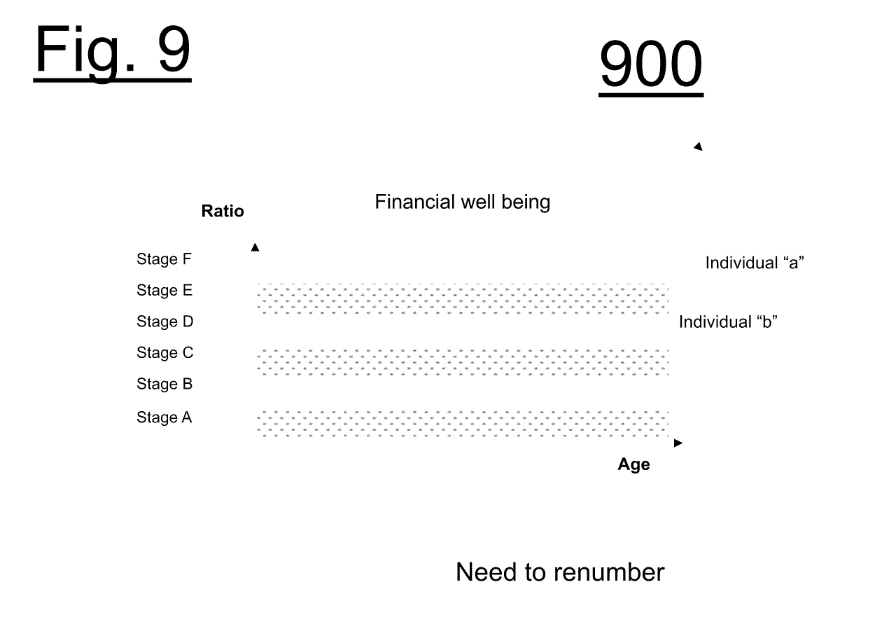

FIG. 8A is an exemplary graph 800 of one financial well being metric, net worth/income as a function of age.

FIG. 8B is an exemplary graph 802 of another financial well being metric, liquid assets/annual expenses as a function of age.

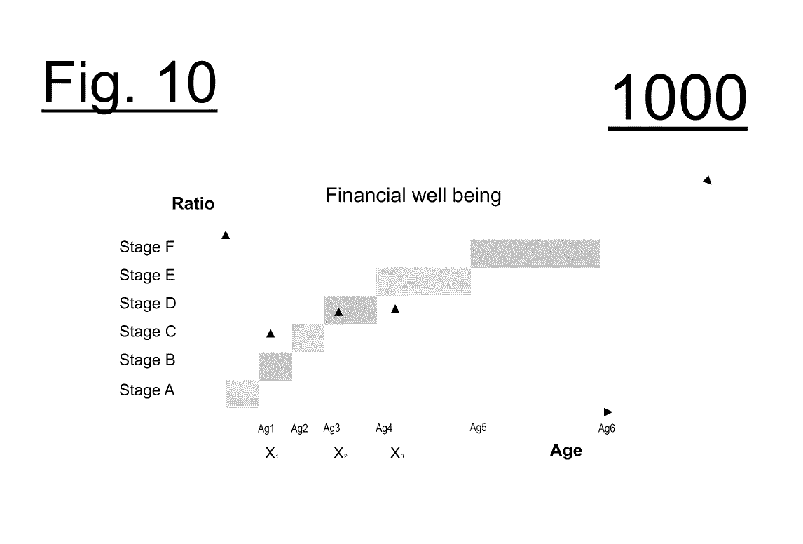

FIG. 9 is an exemplary graph 900 that depicts progress of two individuals (a and b) with the vertical axis divided into stages (A-F). People move from one stage to the other based on the measurement ratio. Optionally, if a user passes a threshold ratio of the metric of FIG. 8B, FIG. 8A becomes relevant.

### Exemplary Formulas & Database Lookups

NW=IE+E+RE+NM+L Equation 1

Equation 1 illustrates that, in some exemplary embodiments of the invention, net worth (NW) can be defined by summing Interest Earning Assets (IE), Equities (E), Real Estate (RE), Non-Marketable assets (NM) and Liabilities (L). Liabilities are, of course, negative, relative to the other terms in equation 1.

IE=C+MM+S+B+BS Equation 2

Equation 2 illustrates that, according to some exemplary embodiments of the invention, IE can be defined as the sum of Balance in checking accounts (C), Money Market accounts (MM), Savings accounts (S), market prices of Bonds (B) and market prices of Bond Funds (BS). Optionally, B and/or BS may be input by a user through the interview engine or retrieved from an available lookup table provided on the network. In some exemplary embodiments of the invention, the analytic module formulates suitable queries and directs them to relevant external sources of information.

E=ST+STF Equation 3

Equation 3 illustrates that, according to some exemplary embodiments of the invention, E can be defined as market prices of Stocks (ST) plus market prices of Stock Funds (STF). Again, market prices can be available from user input and/or lookup tables.

RE=H+RP+SRE Equation 4

Equation 4 illustrates that, according to some exemplary embodiments of the invention, RE can be defined as Market value of Home (H)+market value of rental properties (RP)+Market value of Speculative Real Estate (SRE). Again, these values may be input by the user or determined from lookup tables.

NM=B+C+PU+ONM Equation 5

Equation 5 illustrates that, according to some exemplary embodiments of the invention, NM can be defined as Business ownership (B)+Collectables (C)+Assets for Personal Use (PU)+Other None-Marketable assets (ONM)

L=MH+MRP+MSRE+ONM+CC+CI+SL+OT Equation 6

Equation 6 illustrates that, according to some exemplary embodiments of the invention, L can be defined as Mortgage on home (MH)+mortgage on rental properties (MRP)+mortgage on Speculative Real Estate (MSRE)+Credit Card debt (CC)+Car Lease (CL)+Student Loans (SL)+Other Types loans (OT).

I=SL+BN+SS+P Equation 7

Equation 7 illustrates that, according to some exemplary embodiments of the invention, Income (I) can be defined as Salary (SL)+Bonuses (BN)+Social Security (SS)+Pension (P).

LA=IE+E Equation 8

Equation 8 illustrates that, according to some exemplary embodiments of the invention, Liquid assets (LA) can be defined as Interest Earning Assets (IE)+Equities (E).

$$Annual Expenses ( AE ) = \{ \begin{matrix}Income ( I ) - Savings ( SV ) - Taxes ( TX ) & Age < 50 \\ Actual or Estimated Expenses ( {AE}^{′} ) & Age >= 50\end{matrix} \qquad Equation 9$$

Equation 9 illustrates that, according to some exemplary embodiments of the invention, Annual Expenses (AE) may be calculated differently after a certain age threshold (e.g. age 50). Optionally, before age 50, AE is expressed as the result of Income (I) minus Savings (SV) minus Taxes (TX). Alternatively or additionally, at age 50 and beyond AE is expressed as Actual or Estimated Expenses (AE′).

Table 1 presents an exemplary set of algorithms for calculation a financial position (FP) based upon equations 1 to 9 or similar calculations.

TABLE 1
Exemplary calculation of Financial position (FP)
Financial Position (FP)

| | |
|---|---|
| Stage A (STA) | (NW)/(I) < 1 |
| Stage B (STB) | 1 =< (NW)/(I) < 3 |
| Stage C (STC) | 3 =< (NW)/(I) < 7 |
| Stage D (STD) | 7 =< (I)/(LA) < 10 |
| Stage E (STE) | 10 =< (I)/(LA) < 15 |
| Stage F (STF) | (I)/(LA) >= 15 |

Exemplary Financial Planning Timeline Deviation

FIG. 10 is a graph 1000 illustrating that people are expected to migrate from one financial stage to the other as they get older. According to some exemplary embodiments of the invention, age boundaries for each stage (e.g., Ag1, Ag2) are defined as illustrated in table 2. Optionally, these boundaries define Age Positions (AP) as illustrated in table 3.

No deviation occurs when an individual is at a given financial stage within the pre-defined age boundaries as demonstrated in example X₂ in the illustration below. This individual is “on-target”.

A positive deviation occurs when an individual achieved a given financial stage at a younger age then the low-end boundary defined for that stage as demonstrated in example X₁ in the illustration below. The individual in this example is (Ag2-X₁ years) “ahead of target”.

A negative deviation occurs when an individual achieved a given financial stage at an older age then the high-end boundary defined for that stage as demonstrated in example X₃ in FIG. 10. The individual in this example is (X₃-Ag4 years) “behind target”.

TABLE 2
Exemplary calculation of Age position (FP)
Age Position (AP)

| | |
|---|---|
| Stage A (STA) | 0 =< X < Ag₂ |
| Stage B (STB) | Ag₂ =< X < Ag₃ |
| Stage C (STC) | Ag₃ =< X < Ag₄ |
| Stage D (STD) | Ag₄ =< X < Ag₅ |
| Stage E (STE) | Ag₅ =< X < Ag₆ |
| Stage F (STF) | X >= Ag₇ |

TABLE 3
Exemplary calculation of Time line Deviation (TD)
Age Position (AP)

| | |
|---|---|
| 0 | FP = AP |
| TD = Agi(AP) − X | FP > AP |
| TD = X − Agi(AP) | FP < AP |

Where Agi(AP) = high-end boundary of Age Position
Agi(AP) = low-end boundary of Age Position

Exemplary Risk Capacity Determination

Risk-reward is an underlying foundation in recommending investor's portfolio makeup.

Risk Tolerance, the level of risk people are willing to assume with their investment, is typically used to select a mixed portfolio of specific allocation of stocks and bonds. The challenge most people face is to determine their risk tolerance thus the common practice in the industry is to calculate people's risk tolerance based on their answers to questions such as their relative score for the importance of capital appreciation vs. growth, prevention of money loss, and volatility of their investments' value.

Risk Capacity is defined as the level of risk people should take. A Risk Capacity (RC) score is calculated based on people specific financial life conditions that are broader then the ones that impact their risk tolerance. Such factors include:
Savings Level (SL)=% of savings vs. annual income. People with high level of savings could take more risk with their investments.

TABLE 4
Exemplary contribution of savings level (SL) to risk capacity

| contribution to | |
|---|---|
| risk capacity (X_{SL}) | SL % |
| −1 | <8 |
| 0 | 8 to 12 |
| 1 | ≧12 |

TABLE 5
Exemplary contribution of Income Stability (IS) to risk capacity

| contribution to | |
|---|---|
| risk capacity (X_{IS}) | Income Stability (IS) |
| −1 | high level of income volatility |
| 0 | W2 employee, salary based income |
| 1 | guaranteed income such as |
| | government employee |

Tables 4 and 5 illustrate contributions of exemplary factors such as savings level (SL) and income stability (IS) to risk capacity.

Table 6 shows that households with two sources of income can assume more risk with their investments.

TABLE 6
Exemplary contribution of Income provider
number (IPS) to risk capacity

| contribution to | |
|---|---|
| risk capacity (X_{IP}) | Income Providers (IP) |
| −1 | no income |
| 0 | single income provider |
| 1 | 2 income providers |

Table 7 shows that households with children or elderly who depends on income providers should assume less risk with their investment portfolios.

TABLE 7
Exemplary contribution of Dependent number (DP) to risk capacity

| contribution to | |
|---|---|
| risk capacity(X_{DP}) | Dependents (DP) |
| −1 | household with dependents |
| 0 | household with no dependents |

RC=(X_{SL})+(X_{IS})+(X_{IP})+(X_{DP}) Equation 10

Equation 10 illustrates that the total risk capacity (RC) is calculated, in some exemplary embodiments of the invention, as the sum of the contributions of SL, IS, IP, DP. Optionally, other factors can contribute to risk capacity.

Exemplary Asset Reallocation Recommendation

Each financial asset, marketable (e.g., stocks) or non-marketable (e.g., collectables), is assigned a Functional Asset Category such as Bonds, Income property, Home, or Emergency Liquidity. Relative targets are defined for each class. For example, the target for Emergency Liquidity is X times mortgage payment. Equity in peoples' home is 20%-50% of its market value. Asset reallocation recommendations are based on the difference between peoples' current investment/equity and set targets.

Table 8 shows a division into functional asset categories (FAC) according to some exemplary embodiments of the invention. Optionally, additional and/or different FAC are employed.

TABLE 8
Exemplary Functional asset Categories (FAC)

| Category | asset |
|---|---|
| FAC₁ | Cash on hand |
| FAC₂ | Emergency |
| FAC₃ | Personal home |
| FACi | Venture capital |

FACⱼ₃=FACⱼ₁−FACⱼ₂ Equation 11

CB of FACⱼ=FACⱼ₄−FACⱼ₃ Equation 12

Equation 11 shows that the current investment FACⱼ₃ for a specific FACⱼ is equal to the sum of Asset value (FACⱼ₁) less debt associated with the asset (FACⱼ₂).

Equation 12 shows that the Current balance (CB) for is the difference between a Target investment (FACⱼ₄) and FACⱼ₃. Depending upon the situation CB can be positive or negative or zero. If CB is positive, allocation, or re-allocation, of assets into FACⱼ is indicated. If CB is negative, allocation, or re-allocation, of assets out of FACⱼ is indicated. If CB is zero, no allocation, or re-allocation, of assets with regard to FACⱼ is indicated.

Exemplary Use of Algorithms in a Computerized System:

In some exemplary embodiments of the invention, a computer system (e.g. as depicted in FIG. 1 and described hereinabove) assigns each financial asset (market value and/or debt) to its class by lookups to a codes table for mapping.

Optionally, the computer system adds up all assets in a given Functional Asset Category (FAC), and calculates the balance of Current Investment (FACⱼ₃).

Optionally, the computer system totals the value of Current Investment ΣFACⱼₙ.

In some exemplary embodiments of the invention, the computer system sets Target investment levels (FACⱼ₄) for each Functional Asset Category (FAC) by using pre defined rules that vary by Functional Asset Category (FAC). Optionally, the computer system derives Asset Reallocation recommendations based on the gap between Current investment (FACⱼ₃) and Target investment (FACⱼ₄)

Exemplary Diversification Rules Among Interest Earning, Equities, and Real Estate Assets

(IAIH)=FACⱼ₁(IE′)+FACⱼ₁(E′)+FACⱼ₁(RE′) Equation 13

Equation 13 indicates that Investable Assets Including Home (IAIH) is the sum of market value of Functional Asset Categories (FACⱼ₁) grouped into three Asset Groups (AG): Interest Earning (IE′), Equities (E′), and Real Estate (RE′) assets. Non-Marketable assets (NM) are included in calculation of NW but excluded in Investable Assets Including Home (IAIH). For the purpose of diversification rules, these three asset groups are considered.

Actual diversification is compared with border guidelines for IE, E, RE. In some exemplary embodiments of the invention, deviation from border guidelines is evaluated considering RE first. Table 9 depicts theoretical evaluation of RE allocation with respect to minimum value X1 and maximum value X2 expressed as percentages of Investable Assets Including Home (IAIH).

TABLE 9
Exemplary borders for RE

| | Reallocation | Reallocation |
|---|---|---|
| Border values | indicated if: | type |
| minimum X₁% | (RE′) < X₁ | Allocate more assets |
| | | into real estate |
| Maximum X₂% | (RE′) > X₂ | Divert real estate |
| | | assets into other AG |
| Acceptable range X₃% | X₁ ≦ (RE′) ≦ X₂ | NA |

In case the variance of Real Estate (RE') is outside its border guidelines (first two lines of table 9), targets for all three AGs are based on the following rules:

%(TIE)=[1−(TRE)]*[database lookup with Risk Capacity (RC) and Financial Position (FP)] Equation 14

Equation 14 shows that Target Interest Earning % (TIE) can be expressed as [1−(TRE)] times a [database lookup with Risk Capacity (RC) and Financial Position (FP)]. According to this example, the lookup returns a split between IE and E and relative portions are assigned. For example, if TRE is 30% the amount available to split between IE and E is 70%. If the split of IE & E is 50/50 35% is assigned to IE and 35% is assigned to E.

%(TE)=[1−(TRE)]*[database lookup with Risk Capacity (RC) and Financial Position (FP)] Equation 15

Equation 15 shows that Target Equities % (TE) can be expressed as [1−(TRE)] times a [database lookup with Risk Capacity (RC) and Financial Position (FP)]. Mechanics of assignment are similar to those described for Equation 14.

In case the variance of Real Estate (RE') is within its border guidelines (third line of table 9; TRE=X₃%), targets for all three AGs are based on the following rules:

%(TIE)=[1−X₃%]*[database lookup with Risk Capacity (RC) and Financial Position (FP)] Equation 16

Equation 16 shows that Target Interest Earning % (TIE) can be expressed as [1-X₃%] times [database lookup with Risk Capacity (RC) and Financial Position (FP)]. Mechanics of assignment are similar to those described for Equation 14.

%(TE)=[1−X₃%]*[database lookup with Risk Capacity (RC) and Financial Position (FP)] Equation 17

Equation 17 shows that Target Equities % (TE) can be expressed as [1−X₃%] times [database lookup with Risk Capacity (RC) and Financial Position (FP)]. Mechanics of assignment are similar to those described for Equation 14.

Exemplary Impact of Tax Regulation on Asset Re-Allocation Recommendations

Functional Asset reallocation recommendation is a definition of money movements resulting from difference between Current investment (FACⱼ₃) and Target investment (FACⱼ₄) in specific Functional Asset Categories (FACⱼ).

Asset location recommendation is a definition of specific asset types within a Functional Asset Category.

Taxes play a significant role in asset location recommendations. For example, whether to build Emergency reserves (FAC₂) within qualified retirement plans (QRPs) depends on the specific types of QRPs being considered. Some QRPs bear advantages such as an employer match to employee contributions and/or tax deferment of realized gains. Optionally, employer matching is “free” money for the employee that accelerates wealth creation. Optionally, tax deferment of realized gains accelerates wealth creation.

Some QRPs such as 401k allow participants to take a personal loan against the balance in the plan. In case of emergency this feature can be advantageous. In case the plan rules do not allow such a loan, people may withdraw money from their QRPs, pay taxes and penalty for it. In case of emergency people's tax rate is lower then it was while they were working and the tradeoff between the implications of early withdrawal vs. building emergency reserves outside a QRP are in favor of using QRPs.

Optimizing Tax Shelter Utilization

In some exemplary embodiments of the invention, the principle that people should take advantage of tax shelters the tax authority offers them in accelerating wealth creation is applied. Optionally, people should optimize pre-tax and after-tax savings in QRPs within their limitations and constraints considering their income level and their cost of living.

The following example of optimizing tax shelter utilization in contributions to pre-tax QRPs provides both recommendations and estimated wealth creation. In some exemplary embodiments of the invention, the interview engine 110 prompts input from the user in the form of Self Age (SA); Partner Age (PA) [when applicable]; Self Qualified Retirement Plans (SQRP); Partner's Qualified Retirement Plans (PQRP) [when applicable]; Self Employment status (SES); Partner's Employment status (PES) [when applicable]; Current self annual contributions to (SCQRP); Current partner annual contributions to (PCQRP) [when applicable]; Current household annual savings to non-QRPs (ASNQRP); Current household income (HI) and Marital status (MS).

In some exemplary embodiments of the invention, analytic module 120 performs the following analyses and/or calculations:

1. Determine maximum contribution allowed (Self—SMCA, Partner—PMCA) in existing QRPs applying lookups at databases with limitations and constraints considering for example active QRPs, Age (SA, PA), annual contribution levels (SCQRP, PCQRP);

2. Determine maximum contribution allowed (Self—SMCA, Partner—PMCA) where Self and/or Partner do not have QRPs applying lookups at databases with limitations and constraints considering for example employment status (SES, PES), Age (SA, PA), Marital status (MS);

3. Output maximum contribution recommendations (MCR).

MCR=SMCA+PMCA Equation 18
IF (SMCA+PMCA+ASNQRP)/HI≦x %

MCR=HI*x % Equation 19
IF (SMCA+PMCA+ASNQRP)/HI≧x %

Equations 18 and 19 show exemplary Maximum Contribution Recommendations (MCR) when X % represents a pre-defined max household savings level. If X % is not reached, equation 18 is appropriate and both “self” and “partner” make the maximum contribution allowed. If X % is matched or exceeded, equation 19 is appropriate and both “self” and “partner” contribute to reach X %. Optionally, self or partner's plan can serve as the main recipient of this contribution depending on plan features as described above and/or applicable limits imposed by relative incomes.

ICR=MCR−SCQRP−PCQRP Equation 20

Equation 20 illustrates that increased contribution recommendations (ICR) equals MCR less spouse contribution to QRP (SCQRP) less person's contribution to (PCQRP).

In some exemplary embodiments of the invention, the system employs one or more database lookup tables to determine applicable federal tax (FT) and state tax (ST) levels.

In some exemplary embodiments of the invention, the system then calculates Net Present Value of increased contributions recommendations (NICR) over n years. Optionally, the following equations are used:

ATC=(ICR)*(1−FT−ST) Equation 21

PTC=(ICR) Equation 22

NPV(ATC)=(ATC)*[(1+x %)̂n−1]/x % Equation 23

NPV(PTC)=(PTC)*[(1+x %)̂n−1]/x % Equation 24

NICR=NPV(PTC)−NPV(ATC) Equation 25

Equation 21 illustrates that After Tax Contributions (ATC) can be expressed as (ICR) times (1−FT−ST).

Equation 22 illustrates that Pretax Contributions (PTC) equal Increased contribution recommendations (ICR).

Equation 23 illustrates that the net present value of after tax contributions [NPV(ATC)] equals ATC times {[(1+x %)̂n−1]/x %} where X is a defined annual rate of return and n is the number of years.

Equation 24 illustrates that the net present value of pre-tax contributions [NPV(PTC)] equals PTC times [(1+x %)̂n−1]/x % where X and n are as in equation 23.

Equation 25 illustrates that the Net Present Value of increased contributions recommendations (NICR) equals the net present value (NPV) of pretax contributions (PTC) less the NPV of after tax contributions (ATC) where X and n are as defined above.

These equations demonstrate that as X and/or n increase, the NICR increases by a greater amount for each increased contribution to retirement savings in a QRSP.

Optimizing Investment Expenses

Brinson, Hood & Beebower, 1986 (Gary P. Brinson, L. Randolph Hood, and Gilbert L. Beebower, Determinants of Portfolio Performance, The Financial Analysts Journal, July/August 1986.) suggested that as much as 91.5% of portfolio performance can result from its asset allocation. In some exemplary embodiments of the invention, reduce this principle to a computerized algorithm for proper asset allocation within a portfolio. Optionally, such allocation can be as important, or more important, than selecting specific securities, mutual funds, and/or other financial vehicles. In some exemplary embodiments of the invention, computerized systems analyze fees charged by brokerage accounts and/or QRSPS and/or mutual funds and attempt to identify additional opportunities for savings in the form of reduced fee expenditures. As with the contribution analysis of equations 21 to 25, X and n will have a significant impact on value of savings in the form of reduced fee expenditures at retirement.

In some exemplary embodiments of the invention, the following type of optimization analysis for investment expenses can provide recommendations and/or estimated wealth creation. In equations 26 to 33 the following acronyms are employed:
Money Market Fund Management expense ratio (MFE)
Bond Fund Management expense ratio (BFE)
Domestic Fund Management expense ratio (DFE)
International Fund Management expense ratio (IFE)
Where x %=pre-defined annual rate of return
   n=number of years

(MFX)=(MFE)*(BM) Equation 26

(BFX)=(BFE)*(BB) Equation 27

(DFX)=(DFE)*(BD) Equation 28

(IFX)=(IFE)*(BI) Equation 29

(NPVME)=ΣBMᵢ*(1+x %−ΣMFXi/ΣBMᵢ)̂n Equation 30

(NPVBE)=ΣBBᵢ*(1+x %−ΣBFXi/ΣBBᵢ)̂n Equation 31

(NPVDE)=ΣDMᵢ*(1+x %−ΣDFXi/ΣDMᵢ)̂n Equation 32

(NPVIE)=ΣIMᵢ*(1+x %−ΣIFXi/ΣIMᵢ)̂n Equation 33

Equation 26 illustrates that Money Market Fund expense (MFX) equals (MFE) times the Balance in Money Market fund (BM).

Equation 27 illustrates that Bond Fund expense (BFX) equals (BFE) times the Balance in Bond fund (BB).

Equation 28 illustrates that Domestic Fund expense (DFX) equals (DFE) times the Balance in Domestic fund (BD).

Equation 29 illustrates that International Fund expense (IFX) equals (IFE) times the Balance in International fund (BI).

Equation 30 illustrates that Net Present Value of Money Market funds Expenses (NPVME) equals sum of money in all Money Market funds (ΣBMᵢ) times (1+x %−ΣMFXi/ΣBMᵢ)̂n where x % equals pre-defined annual rate of return, ΣMFXi/ΣBMᵢ equals a weighted average expense ratio of all Money Market funds, and n equals number of years.

Equation 31 illustrates that Net Present Value of Bond funds Expenses (NPVBE) equals sum of money in all Bond funds (ΣBBᵢ) times (1+x %−ΣBFXi/ΣBBᵢ)̂n where x % equals pre-defined annual rate of return, ΣBFXi/ΣBBᵢ equals a weighted average expense ratio of all Bond funds, and n equals number of years.

Equation 32 illustrates that Net Present Value of Domestic funds Expenses (NPVDE) equals sum of money in all Domestic funds (ΣDMᵢ) times (1+x %−ΣDFXi/ΣDMᵢ)̂n where x % equals pre-defined annual rate of return, ΣDFXi/ΣDMᵢ equals a weighted average expense ratio of all Domestic funds, and n equals number of years.

Equation 33 illustrates that Net Present Value of International funds Expenses (NPVIE) equals sum of money in all International funds (ΣIMᵢ) times (1+x %−ΣIFXi/ΣIMᵢ)̂n where x % equals pre-defined annual rate of return, ΣIFXi/ΣIMᵢ equals a weighted average expense ratio of all International funds, and n equals number of years.

In some exemplary embodiments of the invention, one or more recommendations are made based upon this analysis. In equations 34 to 37 the following acronyms and their corresponding symbols are employed:

Recommended Money Market Fund Management expense ratio (RMFE)=s %

Recommended Bond Fund Management expense ratio (RBFE)=t %

Recommended Domestic Fund Management expense ratio (RDFE)=u %

Recommended International Fund Management expense ratio (RIFE)=v %

Where
s %=expense ratio of a pre-defined efficient Money Market fund
t %=expense ratio of a pre-defined efficient Bond fund
u %=expense ratio of a pre-defined efficient Domestic fund
v %=expense ratio of a pre-defined efficient International fund

and where
x %=pre-defined annual rate of return
n=number of years

(RNPVME)=ΣBMᵢ*(1+x %−s %)̂n Equation 34

(RNPVBE)=ΣBBᵢ*(1+x %−t %)̂n Equation 35

(RNPVDE)=ΣDMᵢ*(1+x %−u %)̂n Equation 36

(RNPVIE)=ΣIMᵢ*(1+x %−v %)̂n Equation 37

Equation 34 illustrates that Net Present Value of Recommended Money Market funds Expenses (RNPVME) equals sum of money in all Money Market funds (EBMᵢ) times (1+x %−s %)An where x % equals pre-defined annual rate of return, s % equals expense ratio of a pre-defined efficient Money Market fund, and n equals number of years.

Equation 35 illustrates that Net Present Value of Recommended Bond funds Expenses (RNPVBE) equals sum of money in all Bond funds (ΣBBᵢ) times (1+x %−t %)An where x % equals pre-defined annual rate of return, t % equals expense ratio of a pre-defined efficient Bond fund, and n equals number of years.

Equation 36 illustrates that Net Present Value of Recommended Domestic funds Expenses (RNPVDE) equals sum of money in all Money Market funds (ΣDMᵢ) times (1+x %−u %)An where x % equals pre-defined annual rate of return, u % equals expense ratio of a pre-defined efficient Domestic fund, and n equals number of years.

Equation 37 illustrates that Net Present Value of Recommended International funds Expenses (RNPVIE) equals sum of money in all International funds (ΣIMᵢ) times (1+x %−v %)̂n where x % equals pre-defined annual rate of return, v % equals expense ratio of a pre-defined efficient International fund, and n equals number of years.

Exemplary recommendations to invest in efficient funds based on diversification rules can result in increase wealth creation (IWC) in n years as summarized in equation 38:

(IWC)=(NPVME−RNPVME)+(NPVBE−RNPVBE)+(NPVDE−RNPVDE)+(NPVIE−RNPVIE) Equation 38

Equation 38 illustrates that Increased Wealth Creation (IWC) equals the difference in net present value of recommended fund expenses vs. current fund expenses across the four fund categories: Money Market funds (NPVME−RNPVME), Bond funds (NPVBE−RNPVBE), Domestic funds (NPVDE−RNPVDE), and International funds (NPVIE−RNPVIE)

### Miscellaneous

It is expected that during the life of this patent many types of machine readable media and/or data packet transmission formats will be developed and the scope of the invention is intended to include all such new technologies a priori.

Various exemplary embodiments of the invention as described hereinabove could be integrated into, and/or replace portions of, commercial software application products for Personal Finance which employ “traditional” financial planning decision tools and/or decision making rules. Exemplary products of this type are NaviPlan (EISI Software; Carlsbad Calif.; USA), MoneyGuidePro (Financial planning Smartware; Powhatan; Va.; USA), MoneyTree (Moneytree software; Corvallis; Oreg.; USA), WealthTec (WealthTec LLC Clarksville; Md.; USA), eMoneyAdvisor (eMoney Advisor; Conshohocken, Pa.; USA), JLplanner (J&L Software LLC; Taneytown; Md.; USA) and Quicken (Intuit Inc. Mountain View; Calif.; USA). This list does not purport to be exhaustive.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus (e.g. server or module and/or engine thereof) and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims. Specifically, the invention has been described in the context of financial planning for an individual or family but might also be used to implement financial planning for a small business (i.e. with total assets less than 5 million dollars) by making appropriate changes to the relevant calculations. Alternatively or additionally, specific algorithms may be modified in consideration of individual user needs (e.g. medical conditions or large number of dependents) and/or general economic situation (e.g. recession or prosperity)

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

### APPENDICES

Additional objects, advantages, and novel features of the present invention will become apparent to one ordinarily skilled in the art upon examination of the attached appendices, which are not intended to be limiting. These appendices are an inseparable part of the specification of this application. Alternatively or additionally, each of the various embodiments and aspects of the present invention as delineated hereinabove and as claimed in the claims section below finds support in the appendices which are fully incorporated herein by reference.

Appendix A: Exemplary Financial Checkup (6 pages)

Appendix B: Exemplary Financial plan (27 pages)

1. A computerized server comprising:
a) an interview engine configured to prompt data input pertaining to a user and the user's assets from a user connected to the server;
b) an analytic module adapted to apply a set of predetermined rules to said data input, formulate an asset re-allocation suggestion and to output an estimate of potential savings from implementing said asset re-allocation suggestion; and
c) a display engine configured to present the estimate to the user.

2. A computerized server according to claim 1, wherein said display engine is configured to present the asset re-allocation suggestion to the user.

3. A computerized server according to claim 1, wherein said predetermined rules comprise tax regulations.

4. A computerized server according to claim 2, wherein the asset re-allocation suggestion is presented to the user for a fee.

5. A computerized server according to claim 1, wherein said interview engine is further configured to prompt additional data input pertaining to financial life stage and risk capacity from a user connected to the server;
said analytic module is further adapted to apply a set of predetermined rules to said additional data input and to output an estimate of financial position; and
said display engine is further configured to present the estimate of financial position to the user.

6. A computerized server comprising:
a) an interview engine configured to prompt data input pertaining to financial life stage and asset allocation including real estate holdings from a user connected to the server;
b) an analytic module adapted to apply a set of predetermined rules to said data input and output asset allocation advice including an evaluation of what percentage of assets should be allocated to real estate; and
c) a display engine configured to present the asset allocation advice to the user.

7. A computerized server according to claim 1, wherein said interview engine is further configured to prompt additional data input pertaining to current assets and to financial life stage from a user connected to the server;
said analytic module is further adapted to compare said additional data input to a predetermined financial planning timeline; and
said display engine is further configured to present a current position on said financial planning timeline to the user.

8. A computerized server according to claim 1, wherein
said interview engine is further configured to prompt additional data input pertaining to a user and at least one of:
(i) the user's use of available tax shelters; and
(ii) financial management fees paid by the user from a user connected to the server;
said analytic module is further adapted to apply a set of predetermined rules to said additional data input, and to output an estimate of potential savings from implementing an asset re-allocation suggestion; and
said display engine is further configured to present the estimate to the user.

9. A computerized server comprising:
a) an interview engine configured to prompt data input pertaining to financial behavior from a user connected to the server;
b) an analytic module adapted to compare said data input to a projected future need and determine a behavior metric; and
c) a display engine configured to transform the behavior metric to graphic format and present said metric to said user in said graphic format.

10. A computerized server according to claim 9, wherein said data input includes at least one input selected from the group consisting of savings rate (SL), available liquid assets, pension funding ratio, home equity and high interest rate loans.

11. A computerized server according to claim 10, wherein said available liquid assets consider base liquidity separately from emergency reserves.

12. A computerized server according to claim 10, wherein said behavior metric is selected from the group consisting of a savings rate indicator, a base liquidity indicator,
an emergency liquidity indicator, a pension funding ratio, a home size ratio, a real estate leverage indicator and a high interest rate loan ratio.
